(19) United States
(12) Patent Application Publication
(10) Pub. No.: US 2015/0278790 A1
(43) Pub. Date: Oct. 1, 2015

(54) INTELLIGENT RETAIL CONTAINER

(71) Applicant: TOSHIBA GLOBAL COMMERCE SOLUTIONS HOLDINGS CORPORATION, Tokyo (JP)

(72) Inventor: Anil Jain, Bangalore (IN)

(73) Assignee: TOSHIBA GLOBAL COMMERCE SOLUTIONS HOLDINGS CORPORATION, Tokyo (JP)

(21) Appl. No.: 14/227,606

(22) Filed: Mar. 27, 2014

(51) Int. Cl. G06Q 20/20; G01B 11/02; G06Q 10/08; G01G 19/40; B65D 25/10; B65D 43/16

(52) U.S. Cl. CPC G06Q 20/203; B65D 25/10; B65D 43/16; G06Q 10/087; G01G 19/40; G01B 11/02

(57) ABSTRACT

An apparatus, system, and method that includes a retail container forming an enclosure for retaining a product, a measurement device for calculating an amount of the product removed from the container, an output unit causing a display device to display the removed amount and a total price of the removed amount, a printing device for encoding a representation of the total price onto a label, and a controller for updating an inventory system based on the removed amount.

### BACKGROUND

The disclosure relates to retail containers, and more specifically, to retail containers capable of measuring amounts of removed products and generating labeling for the removed products.

Customers of groceries stores or supermarkets are typically required to purchase produce or bulk food items based on the unit weights of the selected products. However, customers may not always be aware of the weight or the cost of the products that they have selected, and may be quite surprised, embarrassed, and inconvenienced when they discover how much was selected, and how much it costs. To correct discrepancies between the amount of products selected and the desired amount, customers may make multiple trips between the product containers and a separate weighing station, each time making incremental adjustments to the weight by adding or subtracting product until their desired amount is reached. Even worse, a customer may first discover the discrepancy at checkout, and must decide whether to suspend the checkout process to correct the discrepancy, or to remove the product entirely from their purchase.

Further, during the checkout process, store employees may not be able to quickly identify the produce or bulk food items, the particular codes required to enter the items into the cash register, or the correct price of the items (say, signage at the item's container indicates one price while the register system indicates a second price). The employees may thumb through a reference or call a supervisor for assistance, requiring additional time and adding to customer frustration.

### SUMMARY

According to one embodiment, an apparatus is provided that includes a retail container forming an enclosure for retaining a product, a measurement device that calculates an amount of a product that is removed from the container, an output unit that causes a display device to display the removed amount and a total price of the removed amount, a printing device that encodes a representation of the total price onto a label, and a controller configured to update an inventory system based on the removed amount.

According to another embodiment, a system is provided that includes a plurality of retail containers, each including a measurement device that calculates an amount of a product that is removed from the respective container. The retail system also includes an output unit that causes a display device to display the removed amounts from the respective containers and their total prices. The retail system also includes a printing device proximate to at least one of the plurality of containers and configured to encode representations of the total prices of the respective removed amounts, and a controller configured to update an inventory system based on the respective removed amounts.

According to yet another embodiment, a method is provided that includes calculating an amount of a product removed from a container, and displaying the removed amount and a total price of the removed amount. The method further includes, upon receiving a confirmation signal from an input device, encoding a representation of the total price onto a label, and updating an inventory system based on the removed amount.

### BRIEF DESCRIPTION OF THE SEVERAL VIEWS OF THE DRAWINGS

So that the manner in which the above recited aspects can be understood in detail, a more particular description of embodiments of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a retail system, according to embodiments described herein.

FIGS. 2A-2D depict example configurations of retail containers, according to embodiments described herein.

FIGS. 3A and 3B depict product levels in retail containers, according to embodiments described herein.

FIGS. 4A and 4B depict a retail system, according to embodiments described herein.

FIG. 5 is a block diagram depicting a method for providing services using a retail container, according to embodiments described herein.

To facilitate understanding, identical reference numerals have been used, where possible, to designate identical elements that are common to the figures. It is contemplated that elements disclosed in one embodiment may be beneficially utilized on other embodiments without specific recitation. The illustrations referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

According to several embodiments discussed further below, an intelligent retail container is provided that includes a measurement device for calculating an amount of a product removed from the container, an output unit that causes a display device to display the removed amount and a total price of the removed amount, a printing device configured to encode a representation of the total price onto a label, and a controller configured to update an inventory system based on the removed amount.

The retail container may be advantageously used within any retail setting; in a grocery store, for example, the retail container allows for an improved efficiency for customers selecting produce items (i.e., fruits and vegetables) or any other bulk food items (e.g., nuts, beans, grains, flours, sugars, herbs, spices, snacks, candies, coffees, teas, and so forth). Of course, the benefits of the retail container are similarly apparent in other retail settings; one example might be retail containers holding loose nails, screws, nuts, or bolts at a hardware store.

A customer may use the intelligent retail container to select an amount of a particular product and to quickly determine whether the selected amount is suitable, i.e., whether the selected amount equals (or is acceptably close to) the customer's desired amount, whether that corresponds to a specific amount or to a total price. The intelligent retail container may output a signal to a display device to provide the weight and price, as well as other information, to the customer. The display device may be included in the retail container, or common among multiple retail containers, or in some embodiments may be the customer's own handheld or mobile device, such as a phone or tablet.

The display device may display information from the container in multiple modes. In a first mode, the display device may display a product description and a corresponding unit price for the product, along with other information. In a second mode, which may be activated in response to detecting that a customer has removed some amount of product from the container, the display device may display the amount of product removed from the container and the corresponding total price.

When the customer is satisfied with the selected amount of product, the customer may generate a label containing the amount and price information that may be affixed to the product's new container (e.g., a plastic bag, a box, or some other container for transporting the selected product from the retail container to checkout). When presented at checkout, the label may be scanned (such as by a barcode reader or Quick Response (QR) code reader) or the information may be entered manually by a store employee without the need to re-weigh the products.

The intelligent retail container may permit many weighing and pricing functions to be carried out in the immediate vicinity of the containers, so that customers are not inconvenienced with locating a separate weighing station, and making incremental changes to their product amounts until satisfied with the selected amounts. Additionally, the weighing, pricing, and labeling at the retail container removes a duplicative weighing and pricing by an employee at checkout.

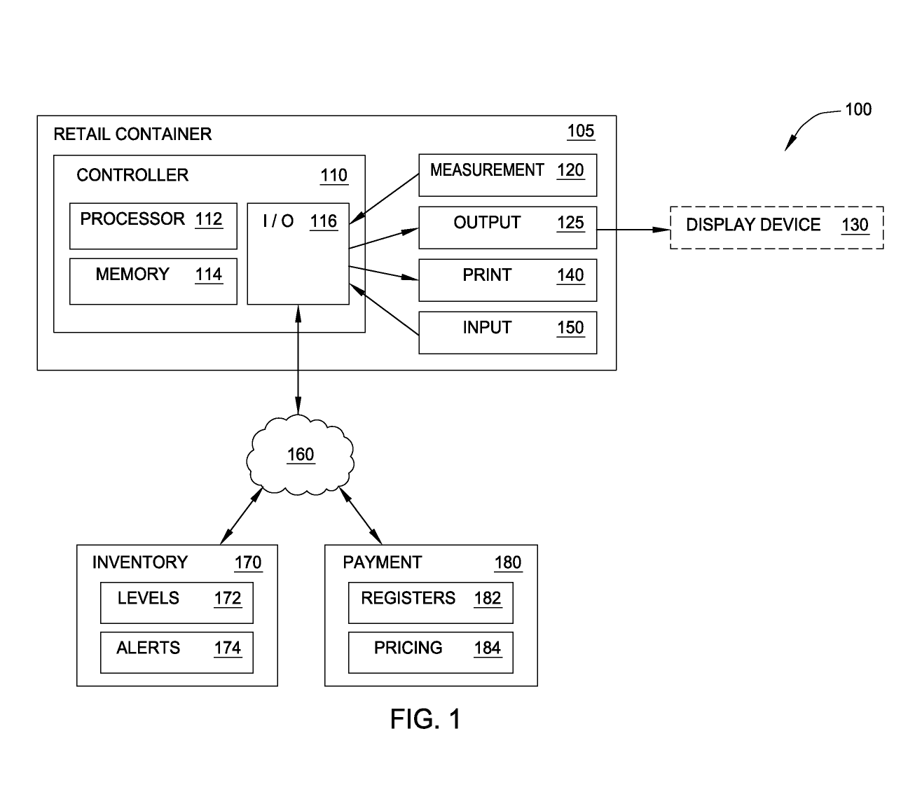

FIG. 1 depicts a retail system, according to embodiments described herein. The retail system 100 includes one or more retail containers 105 that are each configured to hold one or more products. The retail containers 105 may have one or more openings through which products may be added to or removed from the container, for example, manually using a scoop or by operating a dispensing device coupled to the container. The retail containers may include lids, valves, flaps, or other closing devices for partially or fully covering openings when not in use. The retail containers 105 may have any structural configuration or appearance, such as bins, baskets, boxes, buckets, cans, cartons, cases, crates, bags, etc., and may have any shapes and sizes that are suitable for performing the functions described herein. In some embodiments, the retail containers 105 may use designs and sizes that are known or that are standard in a particular industry. The one or more retail containers 105 may generally be arranged in any feasible manner, which may include one or more rows of containers, a vertically stacked arrangement, several containers grouped together and adjacent to one another, and so forth.

The retail container 105 includes a controller 110 that includes one or more processors 112, memory 114, and one or more input/output (I/O) interfaces 116. The processor 112 may comprise any type of processing element, and may include single or multiple processor configurations, multi-core processors, etc. Memory 114 may include one or more different types of memory, such as including both volatile and non-volatile memories. Memory 114 may include, for instance, an amount of random access memory (RAM) as well as storage, such as a hard disk drive (HDD) or solid state drive (SSD), or Flash memory. The processor 112 may generally execute code included in memory 114 to perform the control functions described herein, including communicating with other devices using the I/O interfaces 116.

The I/O interfaces 116 may include one or more paths for communication with various devices or components of the retail container 150 (such as measurement devices, display devices, and input devices which are described more fully below) as well as other external networked devices. The I/O interfaces 116 may include buses, networks, and other wired or wireless interconnections, some examples of which include I²C, SPI, PS/2, Universal Serial Bus (USB), Bluetooth, RF, and IRDA. Communications between devices may use any feasible protocol or combination of protocols; for example, a retail container 105 may communicate with external devices (e.g., other retail containers or computing systems) using TCP/IP protocols, while communicating with local devices using USB protocols.

The retail container 105 may include one or more types of measurement devices 120. The measurement devices 120 are generally configured to determine an amount of a product included in retail containers 105, which may include a weight or volume of the product, a product level (i.e., a height) within the container, and so forth. The measurement devices 120 may use any feasible method for determining the amount of the product, such as measuring the weight of the product directly, or using visual or optical methods to determine a height of the product within the container. Measurement devices 120 may include weight sensors such as strain gages or piezoelectric elements that are capable of measuring weight of products placed into container 105. Measurement devices 120 may also include visual sensors, such as infrared laser or light emitting diode (LED) level sensors, or depth cameras. Other types of sensors may also be used, such as radar, capacitance, and ultrasonic sensors. The measurement devices 120 may be proximate to the retail container 105 (for example, affixed to the container) or may be integrally formed in the container (such as visual sensors embedded in a container wall).

Of course, the product need not have a uniform profile within the container, which may cause a degree of variance in measurement. To compensate for any non-uniformity, measurement devices 120 of different types may be used, and multiple measurement devices of a particular type may be spatially dispersed within the container to sense distribution with greater resolution. The amount of the product in the container may be estimated using the measurements of the various measuring devices 120; for example, readings from various sensors may be provided to the controller 110, which uses some or all of the readings to algorithmically estimate a weight value (or volume, height, etc.) of the product in the container 105. In some embodiments, the measurement devices 120 may take sporadic or periodic measurements, and may use any differences between the measurements to determine whether any product has been added to or removed from the retail container 105, and to determine how much.

In one embodiment, the retail container 105 may be coupled to a dispensing device that meters out product in a preset amount or rate, which may be specified by a user, or which may be a default or a calculated amount or rate. The dispensing device may generally operate using a manually or mechanically-actuated flap, value, or nozzle, which may be particularly useful for containers holding liquid or granular items. Providing controlled dispensing for customers may help to prevent spills, as well as prevent the need to adjust for incorrect amounts of removed product. In this embodiment, the measurement devices 120 may further include measurement devices within the dispensing device to measure the weight of a separated portion for dispensing, or to measure the flow rate of the product, and so forth.

The measurement devices 120 may be communicatively coupled to the controller 110 through I/O interfaces 116 via wired or wireless connections. In some embodiments, measurement devices 120 may provide raw sensor data to the controller 110; in other embodiments, the measurement devices may include logic to convert the raw data into a weight or other value to transmit to the controller 110.

The retail container 105 also includes an output unit 125 configured to transmit a signal to one or more display devices 130, which are generally configured to provide information to customers about the products in the containers. The display device 130 may be included within the retail container 105, or may be external to the container (for example, adjacent to, or in the proximity of the container). In some embodiments, the display device 130 may be disposed at a relatively fixed position, but other embodiments may provide a movable display device, or an entirely mobile display device. For example, display device 130 may be the customer's own handheld or mobile device, such as a phone or tablet carried by the customer; the customer's device may be generally connect to the retail system (and to the retail container) using an application installed on or accessed by the device. In another example, the display device 130 may be included in a separate handheld or mobile device belonging to the retail store, which is loaned to customers during their shopping trip.

The display devices 130 may include any type of display technology, whether conventional or later developed, such as liquid crystal displays (LCDs), light emitting diode (LED) displays, organic LED displays, organic light-emitting transistor (OLET) displays, and so forth. The display devices 130 may be configured to display video signals or may display text and numbers using dot matrix or multi-segment displays. The display device 130 may display data provided by the controller 110, such as a description of the product and its unit price. The display device 130 may also include data related to amounts of product removed from the container. For example, the display device 130 could display in real-time how much product had been removed from the container, as well as its corresponding price, thereby allowing a customer to easily add or subtract until reaching their desired amount.

The display device 130 may operate using several distinct modes, displaying different information in each mode to reflect the different functionality provided to the customers. In a first mode, which could be a default mode for the display device 130, the display device 130 may display basic information about the product, such as a description and unit price, as described above. As a customer interacts with the container, such as by taking product out of the container, the display device 130 may transition to a second mode, where the amount of product that was removed and its corresponding price are displayed. Of course, other information may also be included and displayed in each of the first and second modes, and alternate embodiments may provide more than two modes of display.

As described above, the display device 130 may be provided as a separate device that is coupled or adjacent to a retail container 105, or may alternately be integrally formed as part of the retail container. For example, the display device 130 may include an LCD or other display that is integrated into a wall or a lid of the container, or could be attached or structurally mounted to a container wall or lid. In some embodiments, and as will be described more fully below, a display device 130 may be shared between two or more retail containers 105, so that data from the two or more retail containers may be more easily read by a customer.

The retail container 105 also includes one or more input devices 150 that are generally configured to receive input from users of the container. The input devices 150 may generally provide information to the controller 110 reflecting user preferences or settings for purchasing products. Additionally, the input devices 150 in conjunction with the display device 130 may include a graphical user interface (GUI) for customers who are selecting products from one or more containers, providing menus or other product information in the GUI. The input devices 150 may include any number of known input devices, such as a keyboard, a mouse, a touchscreen interface, knobs, buttons, a directional pad, barcode readers, near field communications (NFC) or other radio frequency identification (RFID) devices, fingerprint scanners, image scanners, and so forth. In one embodiment, the input device and display device are the same device; for example, a touchscreen may display information to a customer and may also receive input from the customer. In another embodiment, the input device and display device may be a customer's handheld or mobile device that is communicatively connected to the retail system using an application installed on or accessed by the device.

In one embodiment, input devices 150 may be used by a customer to specify an amount of product to be removed from the retail container 105. For example, the customer could enter a desired amount of a product into the GUI using the input devices 150; in response, the controller 110 may operate a dispensing device to dispense the product at a desired rate by providing appropriate control signals to a mechanically-actuated flap, value, or nozzle, for example.

The input devices 150 may also provide an administrative functionality to control operation of the retail container 105. For example, store employees may enter a passcode or otherwise provide authentication (such as by scanning an identification card, or by using biometrics) at the input devices 150, and the employees may then modify settings for the particular containers. Of course, when multiple containers are networked together, an employee could feasibly modify settings for one, several, or all the networked containers using input device(s) at a single retail container.

The retail container 105 also includes a printing device 140 that is generally configured to encode data onto a label for a product selected from the retail container; the encoded data may then be read by a scanner at a cash register or at another location in a retail store. For example, the price and weight of the selected product may be encoded onto the label. The labels may be produced by the printing device 140 and then attached to the product or to a plastic bag or other container holding the selected product; alternatively, the labels may not attach to the product but are meant to accompany the product to accommodate checkout. The encoding may be of any feasible type, such as printed barcodes or QR codes that may be visually read; alternatively, the printing device 140 may encode data onto a NFC tag which may be read wirelessly by another NFC device. Correspondingly, the printing device 140 may use any feasible technology for producing the labels, such as inkjet, laser, or thermal printing, and/or may include a communications capability, such as including a NFC device that is capable of writing data onto a NFC tag.

In one embodiment, the printing device 140 may be configured to encode the representation of the data after receiving a confirmation signal provided at an input device 150. While selecting one or more products for purchase, the display device(s) 130 may display an updated listing of the selected product(s) and/or an updated total price. The customer may review the list and price, may make adjustments for item(s) appearing incorrectly on the list, and when satisfied with the results may confirm the order (e.g., through a GUI selection) to direct the printing device 140 to generate the label.

In one embodiment, the retail container 105 may also include an assistive technology device configured to provide information to disabled customers or store employees about the products in the container. Examples of the assistive technology device may include an audio output or a Braille terminal that is communicatively connected to the controller 110 to assist visually-disabled individuals. These devices may generally provide the same or similar information to that provided to a customer by the display device 130. For example, the audio device may describe basic information about the product when a customer first approaches the container, such as a description and unit price. Responsive to a customer interaction with the container, such as by taking product out of the container, the audio device may also describe the amount of product removed and its corresponding price.

The retail container 105 may be networked using I/O interfaces 116 to network 160, where it may be communicatively coupled with other retail containers, as well as with various computing devices included as part of an inventory system 170 and as part of a payment system 180; of course, other types of devices may also be included in the network 160 to provide functionality to the retail system 100. Inventory system 170 may include data (whether being stored in memory, or being transferred or used by computing devices) representing various levels 172 of product stock, including levels of the products currently in the various retail containers of the retail system 100 as well as amounts of the products at various stages of availability (e.g., in a back store room or at a local distribution facility). The inventory system 170 may also include alerts 174 generally relating to the levels 172, which may be transmitted for various conditions of the levels. For instance, an alert may be generated in response to a product level within a particular retail container dropping below a threshold value, indicating that the product needs to be replenished by a store employee. Of course, alerts may be based on numerous other calculations or factors; for example, alerts may also be based on rates at which product is removed from the retail containers, or based on various groupings of retail containers (such as containers having a degree of spatial proximity to each other, or containers which have related products).

The payment system 180 may include data related to the payment for products removed from the retail containers 105. Payment system 180 may include one or more cash registers 182 that are configured to perform a checkout process for customers. The payment system 180 may maintain records for each label generated by the various printing devices 140 included in the retail system, to ensure that the products removed from the containers are ultimately paid for. The payment system 180 may create a database entry each time a label is generated, and may update the entries at checkout (i.e., when the label is scanned at checkout and satisfactory payment made by the customer). Payment system 180 may also compile and analyze data related to the database entries, which may be used to identify loss prevention measures. For example, the payment system may determine that several items located at a certain area of the store have a higher incidence of not being paid for, which could indicate theft or other loss (e.g., spills). The payment system may provide this information to an employee, with or without a recommendation for suitable loss prevention measures (e.g., send employee to check for spills, increase security presence in that area, reconfigure or reposition the containers, etc.).

The payment system 180 may also store pricing information 184 for the various products, which may be accessed through an interface so that a store employee may centrally update pricing for multiple products, and the updated prices may be communicated through network 160 for display and computations at the various retail containers. Of course, this interface could be provided separately (say, at a secure terminal in an employee-only area), or could be accessed at a container's input device 150 (say, after authentication of the employee), or using handheld or mobile devices issued to an employee.

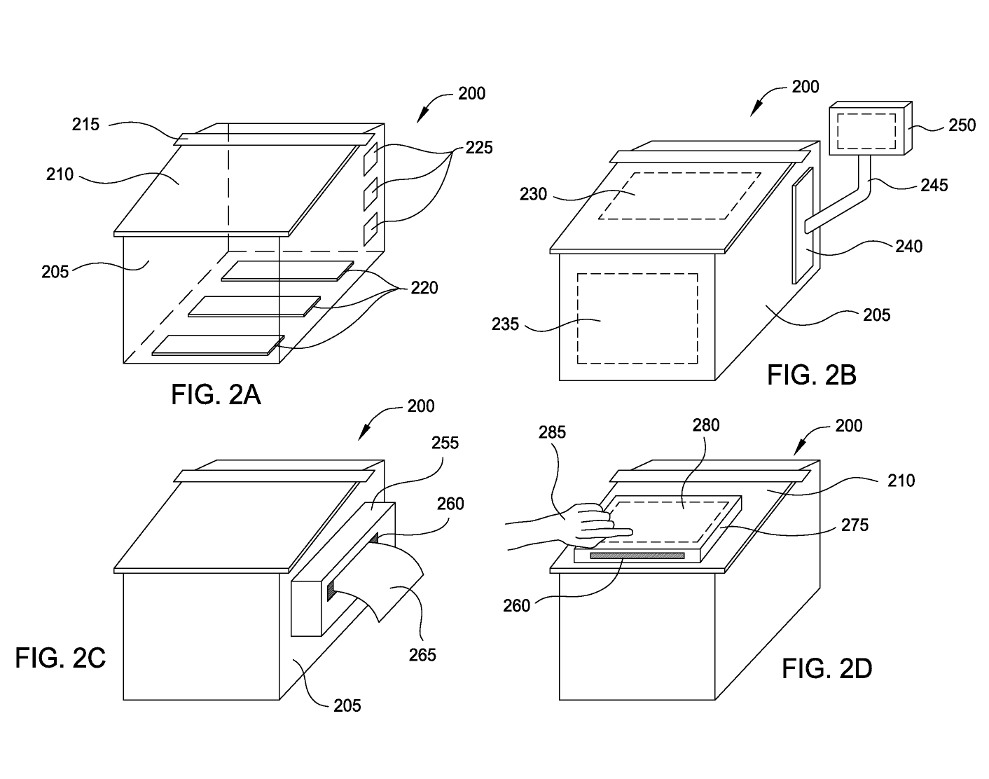

FIGS. 2A-2D depict example configurations of retail containers, according to embodiments described herein. The retail containers may generally include the features of retail container 105 described above, and may be networked similarly. Certain features of the containers that are described above may be omitted from the figures for the sake of clarity; of course, the containers may also include other features that have not been described above.

In FIG. 2A, a bin 200 is depicted having walls 205, a lid 210, and a hinge 215 connecting the lid to the bin. Walls 205 and lid 210 may each have a molded construction, and may be formed using a clear plastic or acrylic. Hinge 215 may be constructed from a flexible material, such as a different type of plastic. Of course, bin 200 is meant to be a single, non-limiting example of a retail container 105. Bin 200 may include one or more types of measurement devices, such as weight sensors 220 and visual sensors 225. The measurement devices may be coupled or adjacent to a surface (e.g., affixed to the walls 225 or lid 210) or may be integrally formed with the surface. The measurement devices may be coupled to a controller (not shown), which may also be included within or adjacent to the container, or integrally formed in the container.

Multiple measurement devices of each type may be used to provide additional data and better resolution. As shown, three weight sensors 220 are disposed along the bottom surface of the bin 200, and three visual sensors 220 are disposed in a wall 205. The output from each of the sensors may be provided to the controller, which may use some or all of the data to determine the level or amount of product within bin 200. This determined level or amount may then be used to generate alerts when falling below a predetermined threshold, which in turn may be provided to an employee to indicate that bin 200 needs to be refilled.

In FIG. 2B, bin 200 also includes a display device, which is generally similar in function to display device 130 described above. The display device may be coupled or adjacent to a surface (e.g., disposed above or below a surface such as a lid or wall) or may be integrally formed within the surface. In either case, the display device may be located at various locations on the bin, such as locations 230 or 235. Any other feasible location in or on the container may also be used, or combinations thereof. In alternate embodiments, the display device may be provided separately from the bin, such as on display 250. Display 250 may be structurally supported by the bin using a mounting assembly that includes a mounting device 240 coupled to the bin, as well as an optional mounting arm 245 that projects from the mounting device and is coupled to the display 250.

In FIG. 2C, bin 200 includes a printer 255, which is generally similar in function to the printing device 140 described above. As shown, the printer 255 is adjacent to bin 200 and structurally supported by a wall 205 of the bin. The printer 255 includes a slot 260, from which a generated label 265 may be removed. As described above, the printer 255 may generally use conventional printing technology or may include the ability to write to a NFC tag.

In FIG. 2D, bin 200 includes a multipurpose device 275 disposed adjacent to lid 210. The multipurpose device may include a combination of some or all of the functional blocks of a retail container described above with respect to FIG. 1, such as controller 110, measurement devices 120, display device 130, print device 140, and input device 150. In one embodiment, an ordinary container may be retrofitted with multipurpose device 275. As shown, multipurpose device includes a touchscreen 280, which may display information about the product contained in bin 200, and with which a user 285 may interact. The multipurpose device 275 may also include a print functionality, as shown by slot 260.

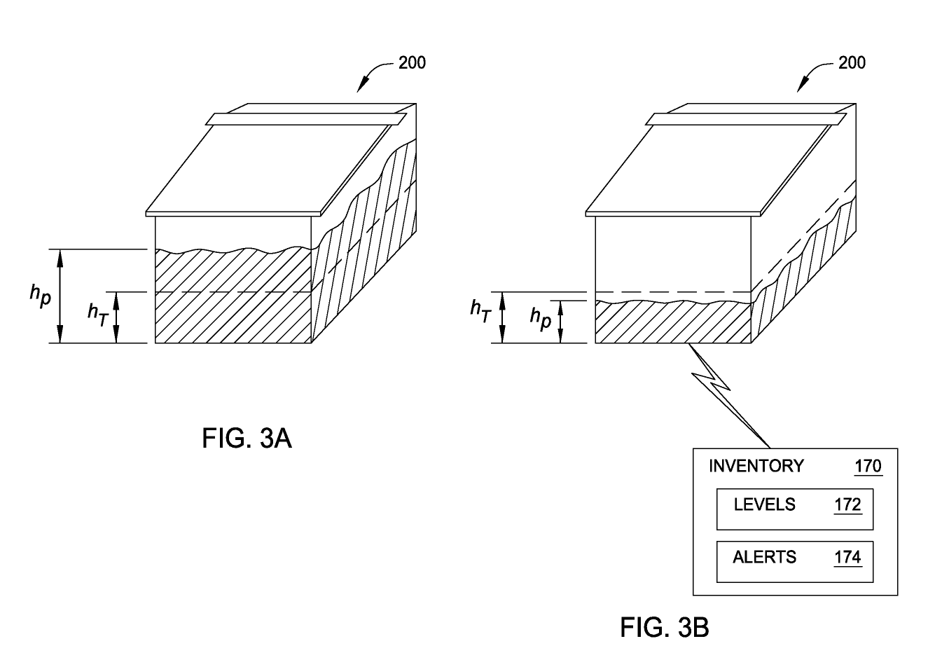

Next, FIGS. 3A and 3B depict product levels in retail containers, according to embodiments described herein. The levels or amounts in a retail container may be used to generate alerts when falling below a predetermined threshold or meeting other criteria, which in turn may be provided to an employee to indicate that bin 200 needs to be refilled. Again, while bin 200 is depicted, the principles and techniques described may be applied to any other retail container 105.

In FIG. 3A, the current product level is at height h_{P}, which is greater than a threshold height h_{T}. The threshold height may be specified by a user (for example, an employee using an input device 150), or may be intermittently or dynamically calculated by a controller based on any number of factors, such as the current height h_{P}, a rate at which the current height is decreasing, historical selection and purchase data for the product (which may be included in database entries corresponding to previously generated labels), and so forth. The controller corresponding to bin 200 may communicate with the inventory system 170 to maintain data on the product levels 172, which in many cases will not cause an alert 174 at its current height h_{P}>h_{T}. Of course, similar techniques may apply for other measures of a calculated amount of product (e.g., weight or volume) when compared to a threshold amount. In FIG. 3B, an amount of product in bin 200 (represented by height h_{P}) is less than the threshold height h_{T}. In response, the controller corresponding to bin 200 may communicate with the inventory system 170 to generate an alert 174 indicating that the bin needs to be refilled, or at least that the condition of then bin requires employee attention.

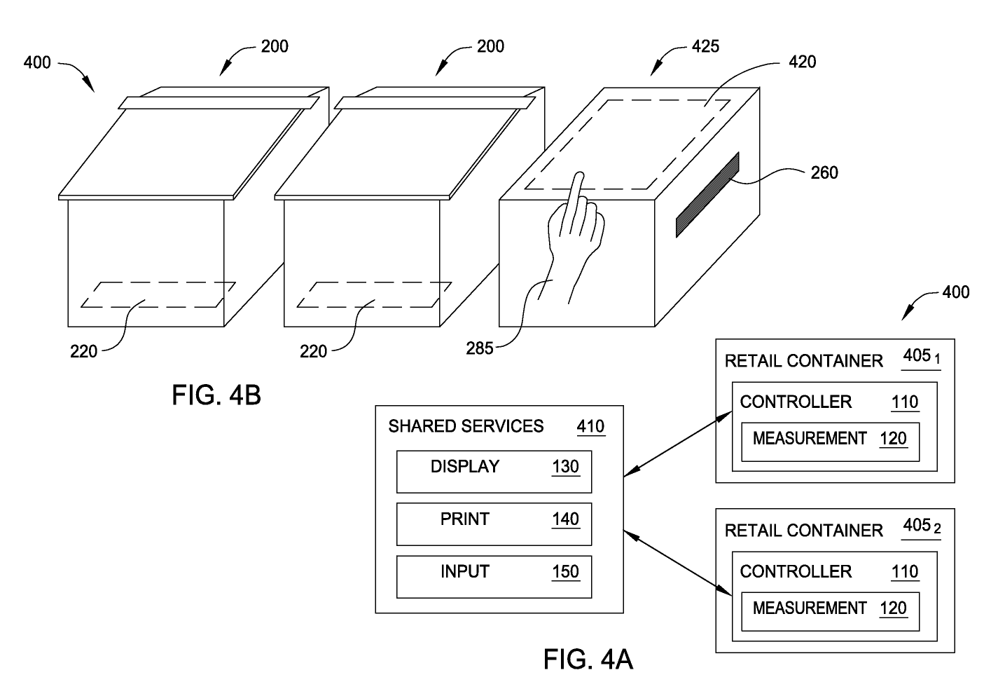

In one or more embodiments, each retail container in the retail system need not provide the entire functionality described above. Instead, certain services of the retail system may be shared between retail containers. Such an implementation may reduce cost (e.g., requiring fewer input devices, display devices, etc.) and still provided an improved customer experience. FIGS. 4A and 4B depict a retail system having one or more shared services. The retail system 400 may generally operate the same or similar to retail system 100, except where noted.

Retail system 400 includes two or more retail containers 405₁, 405₂ and one or more shared services 410. Each retail container may include a separate controller 110 and measurement devices 120, and using the controller 110 may communicate with the shared services module to use the shared services. The shared services 410 may include display devices 130, print devices 140, and input devices 150; in alternate embodiments, a different combination of services may be provided (e.g., only a print device is shared, and each retail container has its own display and input devices), or other services may be provided (such as a shared controller 110).

FIG. 4B depicts an example of the retail system 400. In FIG. 4B, two bins 200 are included in retail system 400, generally having functionality and connectivity as described above. Each bin 200 includes one or more measurement devices for measuring the amounts of product within the bin, such as weight sensors 220, and a controller (not shown). In one embodiment, shared services are provided to the retail system using a separate device, such as a multipurpose device 425. The multipurpose device 425 may include a touchscreen 420 providing display and/or input for the retail system, and a printer (seen as slot 260).

In alternate embodiments, shared services may be provided using functionality included with one or more retail containers. For example, the multipurpose device 275 described above may be included with bin 200, and may provide shared services to one or more other containers, each of which may or may not include a similar multipurpose device 275. Of course, the shared services need not be provided by a single device or correspond solely to one retail container, but for example may use separate devices provided by various containers in the retail system. For example, a display and/or input device for a first container may be shared with other containers of a group; a second container of the group may have a print device which is similarly shared with the group, and so forth.

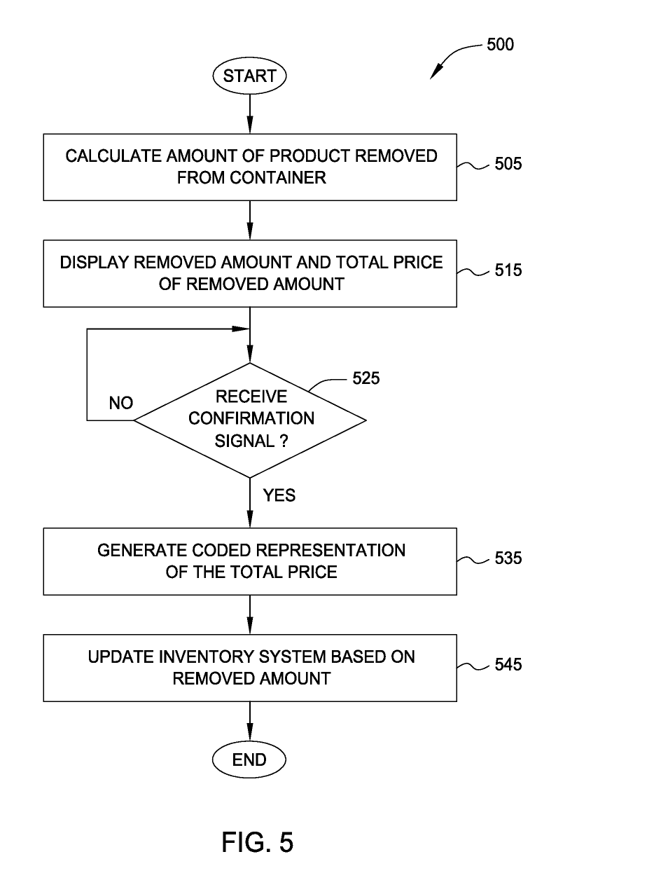

FIG. 5 is a block diagram depicting a method for providing services using a retail container, according to embodiments described herein. The method 500 may generally be used with the retail systems 100, 400, as well as with the retail containers included in those systems. The above description of the operation of these retail systems and retail containers is intended to complement the relatively brief description of the method that follows.

Method 500 begins at block 505, where an amount of a product removed from a container is calculated. This may be accomplished using data provided by one or more types of measurement sensors included with the container, and may include generating an estimate of weight, volume, height within the container, etc. based on the data.

At block 515, the amount of product removed, as well as the total price of the removed amount, is displayed. This block may be performed using an output unit transmitting a signal to a display device (whether corresponding to the individual container, or perhaps shared between containers) as described above. Of course, the display device may be included with the container, proximate to one or more containers, or entirely mobile (in the case of handheld or mobile devices). The information displayed in this block may also represent a second mode for a display device (where in the first mode, basic product information is displayed such as a description and a unit price), and this second mode may be entered upon detecting that an amount of product has been removed from the container.

At block 525, the method determines whether a confirmation signal has been received. The confirmation signal may be provided by a user using an input device, indicating that the product(s) and amount(s) displayed are correct, and indicating that the corresponding label is ready to be generated. If the input device does not receive a confirmation signal within a predetermined period of time (i.e., a timeout period), the display device may return to its first mode (and return to displaying basic product information instead of the most recent product selection interaction).

The displayed information may include a listing of one or more products in one or more amounts. In certain embodiments, shared services are provided across multiple containers in the retail system (e.g., display/input and printing devices), and so the displayed listing may reflect a customer's selections made from multiple containers in a particular area. Of course, multiple customers may interact concurrently with the retail system, so that certain selections not belonging to a particular customer could also be displayed on a display device. Before providing the confirmation corresponding to the product(s) and amount(s) selected by the customer, a customer may be able to indicate (using an input device) which product selections were in fact made by that customer.

At block 535, and after receiving a confirmation of the selections for the customer, a print device may generate a label having a coded representation of the total price of the selections, for example a barcode or QR code, or a NFC tag. Of course, additional information may also be included in the label, which may also be coded or which may be readable by a customer.

At block 545, the retail system may update the inventory system based on the amount of product(s) removed from the container(s). When updated, the new amounts in the inventory system may generate alerts requiring employee attention. The method ends following completion of block 545.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, the retail system, inventory system, and payment system may perform at least some of their functionality using applications or related data available in the cloud. For example, the retail system may provide data related to a customer's product selection to a database stored in the cloud, which data may there be accessed by the inventory and payment systems in order to update the product levels in the inventory system, and to provide loss prevention data to the payment system. Additionally, customers may use their personal handheld or mobile devices to interface with the retail system using applications or data hosted in the cloud. Doing so allows a user of these systems to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. An apparatus, comprising:
a retail container forming an enclosure for retaining a product;
a measurement device operably connected to the container and configured to detect at least some of the product being removed from the container and to calculate a removed amount of the product;
an output unit configured to transmit a signal to a display device and causing the display device to display the removed amount and a total price of the removed amount;
a printing device proximate to the container and configured to encode a representation of the total price onto a label; and
a controller communicatively connected to the measurement device and configured to update an inventory system based on the removed amount.

2. The apparatus of claim 1, wherein the measurement device comprises one or more weight sensors disposed in the container.

3. The apparatus of claim 1, wherein the measurement device comprises a plurality of visual sensors, each configured to detect a respective level of the product, and the controller is further configured to estimate the amount of the product removed on the detected levels.

4. The apparatus of claim 1, further comprising an input device, wherein the printing device is configured to encode the representation in response to a confirmation signal provided to the input device.

5. The apparatus of claim 4, wherein the display device and the input device are the same device.

6. The apparatus of claim 1, wherein the display device is attached to the container.

7. The apparatus of claim 1, wherein updating the inventory system includes transmitting an alert when an amount of the product remaining in the container decreases below a threshold value.

8. A system, comprising:
a plurality of retail containers, each forming an enclosure for retaining a product and comprising a measurement device, the measurement device operably connected to the container and configured to detect at least some of the product being removed from the container and to calculate a removed amount of the product;
an output unit configured to transmit a signal to a display device and causing the display device to display the removed amounts from the respective containers, and total prices of the respective removed amounts;
a printing device proximate to at least one of the plurality of containers and configured to encode a representation of the total prices onto one or more labels; and
a controller communicatively connected to the measurement devices and configured to update an inventory system based on the respective removed amounts.

9. The system of claim 8, wherein the measurement devices comprise one or more weight sensors disposed in the respective container.

10. The system of claim 8, wherein the measurement devices comprise a plurality of visual sensors each configured to detect a respective level of the product, and the controller is further configured to estimate the amount of the product removed based on the detected levels.

11. The system of claim 8, further comprising an input device proximate to at least one of the plurality of containers, wherein the printing device is configured to encode the representation in response to a confirmation signal provided to the input device.

12. The system of claim 11, wherein the display device and the input device are the same device.

13. The system of claim 8, wherein the display device is attached to the container.

14. The system of claim 8, wherein updating the inventory system includes transmitting an alert when an amount remaining in one of the containers decreases below a threshold value.

15. The system of claim 8, wherein the display device and the printing device are provided in a common housing.

16. A method, comprising:
calculating an amount of a product removed from a container;
displaying the removed amount and a total price of the removed amount;
upon receiving a confirmation signal from an input device, encoding a representation of the total price onto a label; and
updating an inventory system based on the removed amount.

17. The method of claim 16, further comprising:
in a first mode, displaying a description of the product and a unit price of the product; and
in a second mode, displaying the removed amount and the total price;

18. The method of claim 17, further comprising switching to the second mode upon detecting that at least some of the product has been removed from the container.

19. The method of claim 17, wherein the display device is further configured to switch to the first mode after a predetermined timeout period.

20. The method of claim 16, further comprising transmitting an alert when an amount of the product remaining in the container decreases below a threshold value.
